(19) United States
(12) Patent Application Publication
(10) Pub. No.: US 2025/0358167 A1
(43) Pub. Date: Nov. 20, 2025

(54) WIRELESS COMMUNICATION WITH DYNAMIC UL GAIN CORRECTION

(71) Applicant: QUALCOMM Incorporated, San Diego, CA (US)

(72) Inventors: Orod RAEESI, Markham (CA); Simran KAUR, San Diego, CA (US); Touseef KHAN, San Diego, CA (US)

(21) Appl. No.: 19/195,261

(22) Filed: Apr. 30, 2025

Related U.S. Application Data
(60) Provisional application No. 63/648,113, filed on May 15, 2024.

(51) Int. Cl. H04L 27/36; H04L 27/26

(52) U.S. Cl. CPC H04L 27/364; H04L 27/2607

(57) ABSTRACT

A method for wireless communication at a distributed unit (DU) and related apparatus are provided. In the method, the DU receives a first open radio access network (O-RAN) fronthaul packet from a radio unit (RU). The UE iteratively applies one or more full scale (FS) offset values from a defined range of FS offset values for a compression type and a corresponding In-phase/Quadrature (I/Q) bitwidth of the compression type for the first O-RAN fronthaul packet from the RU until a metric is met. The DU further receives one or more fronthaul packets from the RU and processes the one or more fronthaul packets from the RU based on an FS offset value identified based on the metric being met.

### CROSS REFERENCE TO RELATED APPLICATION(S)

This application claims the benefit of and priority to U.S. Provisional Application Ser. No. 63/648,113, entitled “WIRELESS COMMUNICATION WITH DYNAMIC UL GAIN CORRECTION” and filed on May 15, 2024, which is expressly incorporated by reference herein in its entirety.

### TECHNICAL FIELD

The present disclosure relates generally to communication systems and, more particularly, to wireless communication gain correction for the distributed unit (DU).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. Some aspects of later wireless communication, such as 6G or others, may be based on aspects of 5G NR and/or 4G LTE. There exists a need for further improvements in 5G NR technology and additional wireless communication technology, including future wireless communication technologies, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a distributed unit (DU). The apparatus may include at least one memory and at least one processor coupled to the at least one memory. Based at least in part on information stored in the at least one memory, the at least one processor may be configured to receive a first open radio access network (O-RAN) fronthaul packet from a radio unit (RU); iteratively apply one or more full scale (FS) offset values from a defined range of FS offset values for a compression type and a corresponding In-phase/Quadrature (I/Q) bitwidth of the compression type for the first O-RAN fronthaul packet from the RU until a metric is met; receive one or more front haul packets from the UE; and process the one or more fronthaul packets from the RU based on an FS offset value identified based on the metric being met.

In an aspect of the disclosure, a method, a computer-readable medium, and an apparatus are provided for wireless communication at a DU. The apparatus may include at least one memory and at least one processor coupled to the at least one memory. Based at least in part on information stored in the at least one memory, the at least one processor may be configured to receive, from an RU, an indication of an N-bit representation used for O-RAN fronthaul packets provided to the DU; identify an FS offset value from the N-bit representation indicated by the RU; and process one or more fronthaul packets from the RU based on the FS offset value identified based on the N-bit representation indicated by the RU.

In an aspect of the disclosure, a method, a computer-readable medium, and an apparatus are provided for wireless communication at an RU. The apparatus may include at least one memory and at least one processor coupled to the at least one memory. Based at least in part on information stored in the at least one memory, the at least one processor may be configured to provide, to a DU, an indication of an N-bit representation used for O-RAN fronthaul packets provided to the DU; and provide one or more fronthaul packets to the DU based on the N-bit representation indicated by the RU.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example usage of the full scale (FS) offset feature.

FIG. 5 is a diagram illustrating an example setup of a distributed unit (DU).

FIG. 6 is a diagram illustrating the different power levels when N-bits compression methods are implemented in some open radio access network (O-RAN) devices.

FIG. 7 is a diagram illustrating a dynamic gain correction method in accordance with various aspects of the present disclosures.

FIG. 8 is a diagram illustrating a dynamic gain correction method in accordance with various aspects of the present disclosures.

FIG. 9 is a call flow diagram illustrating a method of wireless communication in accordance with various aspects of the present disclosure.

FIG. 10 is a flowchart illustrating methods of wireless communication at a distributed unit (DU) in accordance with various aspects of the present disclosure.

FIG. 11 is a flowchart illustrating methods of wireless communication at a DU in accordance with various aspects of the present disclosure.

FIG. 12 is a flowchart illustrating methods of wireless communication at a DU in accordance with various aspects of the present disclosure.

FIG. 13 is a flowchart illustrating methods of wireless communication at a DU in accordance with various aspects of the present disclosure.

FIG. 14 is a flowchart illustrating methods of wireless communication at a radio unit (RU) in accordance with various aspects of the present disclosure.

FIG. 15 is a diagram illustrating an example of a hardware implementation for an example apparatus and/or UE.

FIG. 16 is a diagram illustrating an example of a hardware implementation for an example network entity.

### DETAILED DESCRIPTION

In wireless communication, the compression methods used in an open radio access network (O-RAN) may have a large dynamic range. Some O-RAN-based radio units (O-RUs) may use a fixed-point internal representation, such as N-bit fixed-point, for processing digital signals. For example, the O-RUs may keep the N least significant bits (LSBs) of a signal. To address the potential interoperability issues due to this fixed-point internal representation, a full scale (FS) offset feature may be used to limit the use of the most significant bits (MSBs). In some examples, N-bit compression methods used in O-RAN devices may lead to discrepancies in power levels, due to the reliance on the N least significant bits (LSB), and an RU might configure gain correction, or a distributed unit (DU) may use a set of FS offset values in the carrier configuration phase to address the power discrepancies. However, when the gain correction or the FS offset adjustments are unavailable, uplink (UL) fronthaul (FH) packets might fail to decode because the FH power could fall outside the dynamic power range of DU's processing capability (e.g., the FH power may exceed or fall below the dynamic power range the DU is capable of processing). Example aspects provide methods and apparatus for dynamic UL gain correction for a DU when the RUs cannot apply UL gain correction and the FS offset values are not configured or configured as zero in the DU.

Various aspects relate generally to wireless communication. Some aspects more specifically relate to dynamic UL gain correction on a DU. In some examples, a DU receives a first open radio access network (O-RAN) fronthaul packet from a radio unit (RU); and iteratively applies one or more FS offset values from a defined range of FS offset values for a compression type and a corresponding In-phase/Quadrature (I/Q) bitwidth of the compression type for the first O-RAN fronthaul packet from the RU until a metric is met. The DU further receives one or more fronthaul packets from the RU and processes the one or more fronthaul packets from the RU based on an FS offset value identified based on the metric being met.

Particular aspects of the subject matter described in this disclosure can be implemented to realize one or more of the following potential advantages. In some examples, by allowing for dynamic adjustment of the FS offset based on real-time conditions, the described techniques enhance flexibility in handling various signal conditions. In some examples, by implementing a fallback mechanism that utilizes defined FS offset values when automatic gain correction is not available, the described techniques ensure continuous system operations, even under less than ideal conditions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

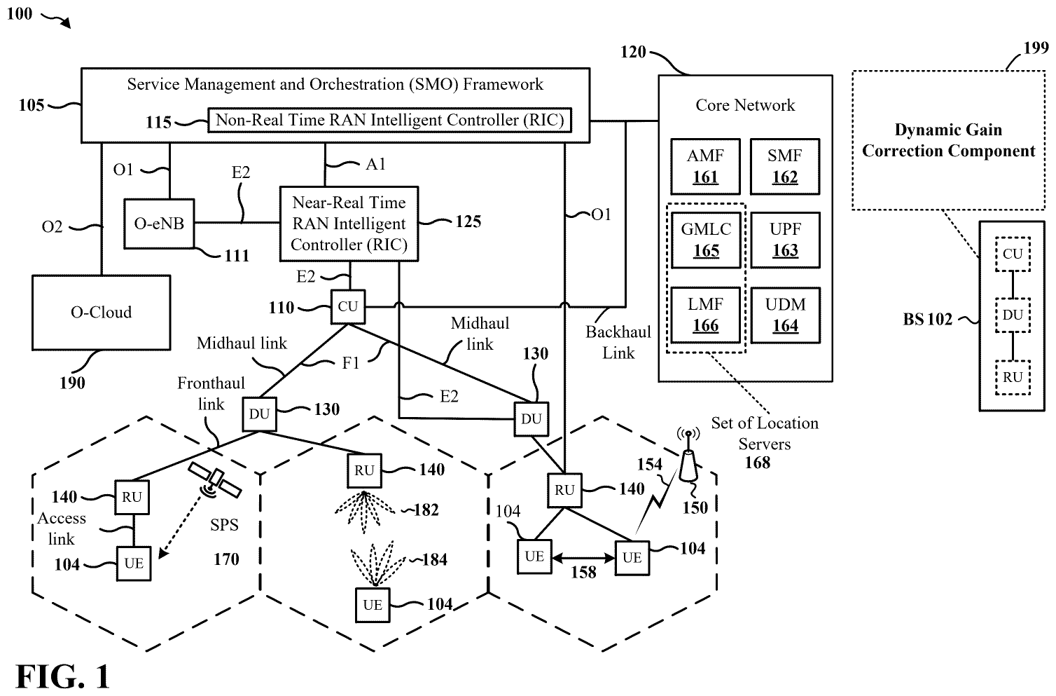

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHZ-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may include a dynamic gain correction component 199. The dynamic gain correction component 199 may be configured to receive a first O-RAN fronthaul packet from an RU; iteratively apply one or more FS offset values from a defined range of FS offset values for a compression type and a corresponding I/Q bitwidth of the compression type for the first O-RAN fronthaul packet from the RU until a metric is met; receive one or more fronthaul packets from the RU; and process the one or more fronthaul packets from the RU based on an FS offset value identified based on the metric being met. Although the following description may give examples based on 5G NR to illustrate concepts relating to wireless communication, the concepts described herein may be applicable to other similar areas, such as LTE, LTE-A, CDMA, GSM, 6G and other wireless technologies.

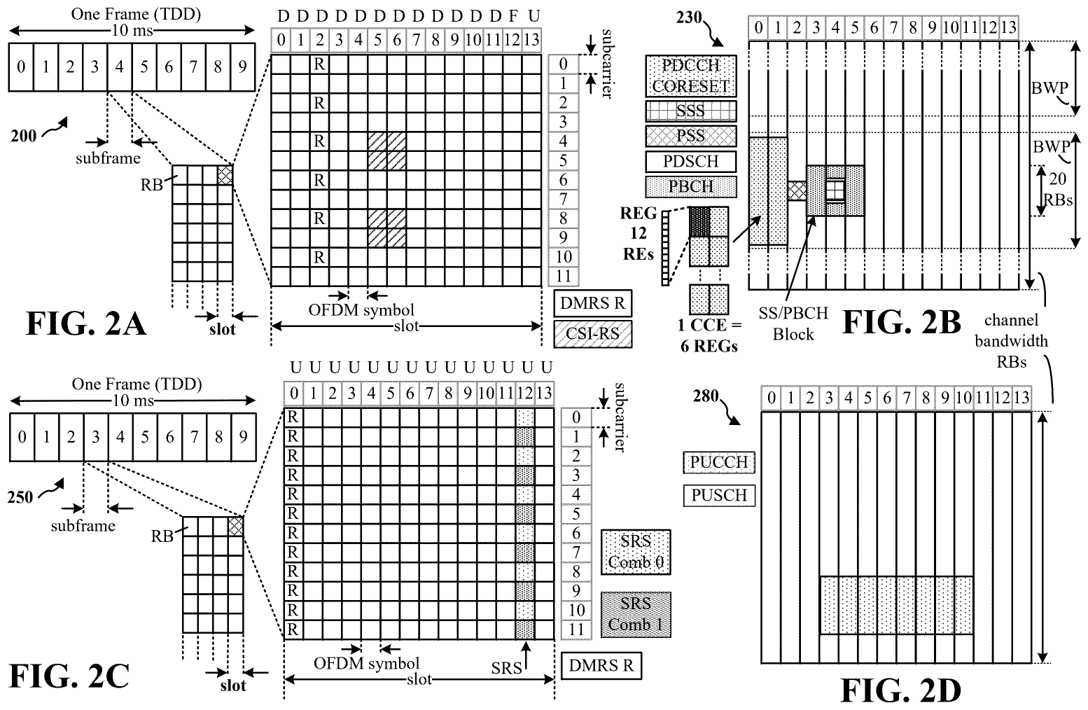

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

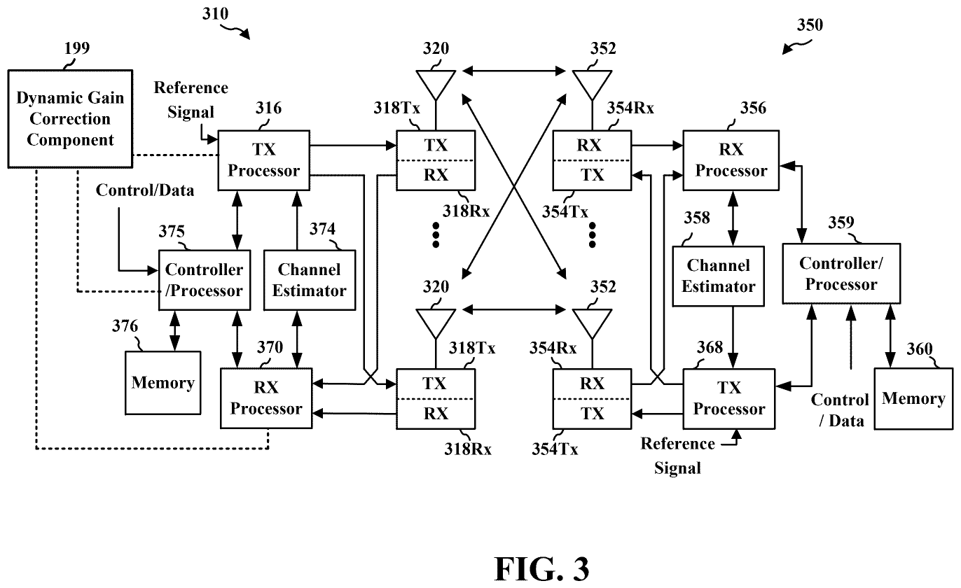

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the dynamic gain correction component 199 of FIG. 1.

Example aspects presented herein provide methods and apparatus for iteratively providing the gain correction in the open distributed unit (O-DU), which may also be referred to as a DU, until decoding performance is acceptable. Example aspects of a DU 130 are described in connection with FIG. 1, for example. These methods and apparatus address issues related to the non-reporting of uplink (UL) gain correction or FS offset values on the open radio unit (O-RU), which may also be referred to as an RU. Example aspects of an RU 140 are described in connection with FIG. 1, for example.

In wireless communication, the compression methods defined in the O-RAN may have a large dynamic range. In some examples, O-RAN based O-RUs with N-bit fixed point internal representations may keep the N least significant bits (LSBs) since I/Q samples may be low in power. For example, data in the signal may be compressed and carried in a subset of the bits. However, this approach may lead to interoperability issues, as different devices may use different subsets of bits (e.g., most significant bits (MSBs) or LSBs). In some examples, an FS offset may be used to descale such outputs to address the interoperability issues. For example, using the FS offset feature, the O-DU and the O-RU may agree on a reduced FS value compared to previous scales. The reduced FS value may ensure that the I/Q data representation transmitted over the fronthaul is limited to a predetermined number of LSBs (e.g., M LSBs), which may be determined based on the FS value. For example, a block-floating point (BFP) configuration with 9 bits may have an FS offset of 2, and a BFP configuration with 14 bits may have an FS offset of 10.

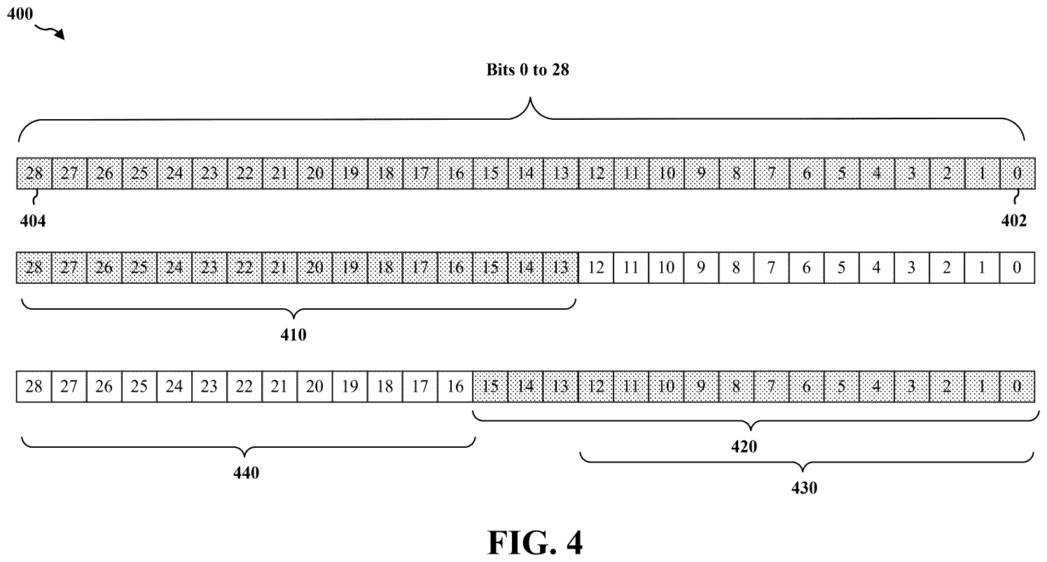

FIG. 4 is a diagram 400 illustrating an example usage of the FS offset feature. In FIG. 4, when the BFP compression with the mantissa size of 14 is used, a total of 29 bits (e.g., bit 0 402 to bit 28 404) per in-phase (I) and quadrature (Q) components may be used to fully represent the signal. Out of the total of 29 bits, 14 bits may be used for the mantissa and a maximum value of 15 (e.g., 4 bits) may be used for the exponent. In some cases, however, some O-RAN-compliant devices may not have the full 29-bit dynamic range internally for each of I and Q components. Instead, these devices may have a smaller capacity, such as N bits, where N may be less than 29 for each of I and Q components. The O-RAN CU does not specify the exact location of the N bits (e.g., whether the N bits are to be the most significant bits (MSBs) or the least significant bits (LSBs)), which leads to inconsistency in how different devices process signals. For example, one device, such as an O-DU, may use the 16 MSBs 410 (bits 13-28) for its internal processing, while another device, such as an O-RU, may use the 16 LSBs 420 (bits 0-15). This disparity results in a loss of 13 bits (e.g., the bits 430 including bits 0-12) during communication between these devices (e.g., between the O-RU and O-DU), which may severely impact signal integrity and data transmission. This issue becomes even more pronounced when the devices (e.g., O-DU or O-RU) have a smaller number of bits for internal processing.

In the example of FIG. 4, when a PRACH transmission is sent from the O-RU to the O-DU, most of the information will be in the truncated bits (e.g., the bits 430) as the PRACH signals may have low power and most of the information may reside within the least significant bits (LSBs). If the O-RU is configured to use a 16-bit fixed-point internal format and retains only these LSBs (and not the other bits of the PRACH transmission), a new full scale (FS) may be defined such that 0 dB full scale (dBFS) may be represented within the 16 bits used by the O-RU. Due to this adjustment, the most significant bits (MSBs) may be defined to be zero. For example, for the 29 bits from bit 0 402 to bit 28 404, using the 16 bits by the O-RU may imply that 13 MSBs (the bits 440) may be set to zero. Hence, the FS offset value may be set at 13*2=26 based on the formula of:

$${I}^{2} + {Q}^{2} \leq F S = F {S}_{0} \cdot {2}^{- FS \_ offset} \qquad ( 1 )$$

In some examples, an implementation of the FS offset feature may provide a range of values for the FS offset. In some examples, the O-RU may advertise all supported compression methods, I/Q bitwidths, and the range of FS offset values for each endpoint. In response, the O-DU may configure one FS offset value for each combination of compression methods and I/Q bitwidths for a given endpoint. It may be assumed that, during the runtime, the DU may use one combination of compression methods, I/Q bitwidths, and FS offset for a combination of component carrier (CC) and endpoint. As used herein, the “I/Q bitwidth” refers to the number of bits used to represent I/Q parts of a sample being transmitted over fronthaul.

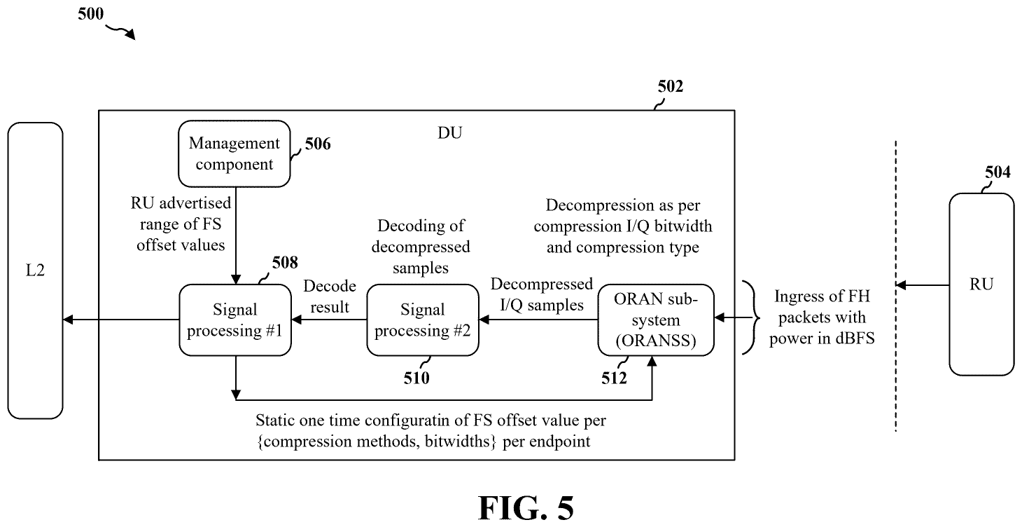

FIG. 5 is a diagram 500 illustrating an example setup of a DU. In FIG. 5, an O-DU 502 may communicate with an O-RU 504. The O-DU 502 may include various components, such as O-RAN sub-system (ORANSS) 512, a management component 506 (which may include, for example, a management plane (M-plane) module), and various signal processing components (e.g., signal processing component #1 508, signal processing component #2 510). For example, the signal processing component #1 508 may include a layer 1 (L1) physical manager, and the signal processing component #2 510 may include an L1 decoder block. The O-RU 504 may advertise all supported compression methods, I/Q bitwidths, and the range of FS offset values for each endpoint, and the O-DU 502 may configure one FS offset value (e.g., via the management component 506) based on the RU-advertised range of FS offset values for each combination of compression methods and I/Q bitwidths for a given endpoint. One signal processing component (e.g., signal processing component #1 508) may provide a static one-time configuration of the FS offset value for each combination of the compression methods and the I/Q bitwidths for the ORANSS 512. Based on the FS offset value, the ORANSS 512 may perform the decompression as per compression I/Q bitwidth and compression type.

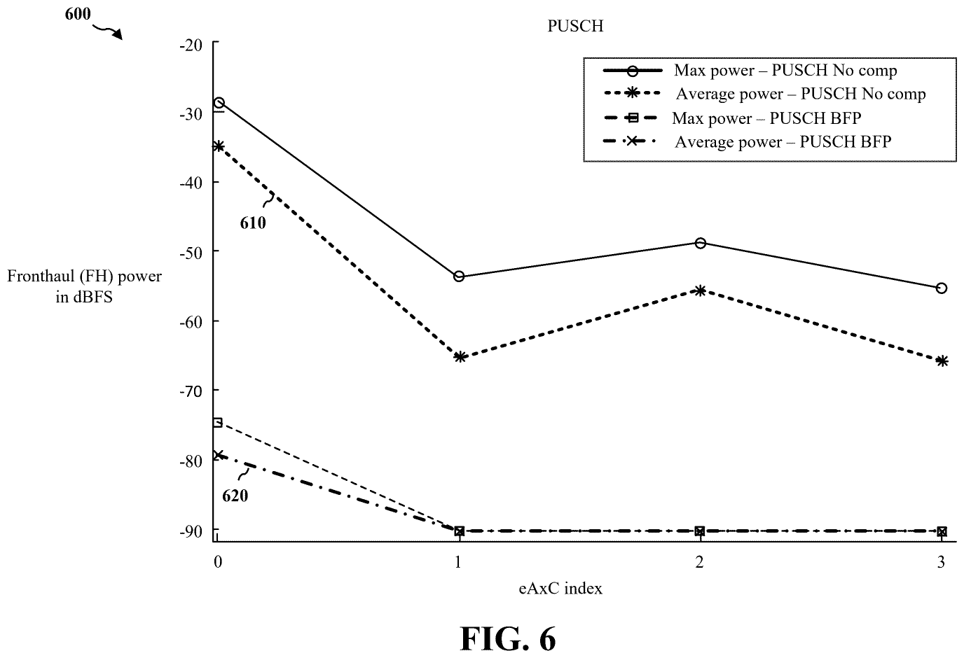

FIG. 6 is a diagram 600 illustrating the different power levels when N-bits compression methods are implemented in some O-RAN devices. As shown in FIG. 6, when N-bit compression methods are used in some O-RAN devices, discrepancies in power levels may arise due to the reliance on the N LSBs. These power discrepancies may lead to excessively low or high power outputs. For example, as shown in FIG. 6, the fronthaul (FH) power in case of no compression may be −35 dBFS, as depicted by curve 610 at extended antenna-carrier identifier (eAxC ID) (x-axis) of 0, whereas with BFP14 compression, the FH power may drop to −80 dBFS, as depicted by curve 620 at eAxC ID (x-axis) of 0. To address this issue, an RU may configure a gain correction, or a DU may use a pre-defined set of FS offset values, which may be configured via a management component (e.g., management component 506) during the carrier configuration phase.

However, when the gain correction and the FS offsets are not applied, or are not supported, the UL FH packets may fail to decode at DU because the FH power may fall outside the DU's dynamic power range. For example, the formula for computing the UL gain is defined in section 8.1.3.2.2 of the O-RAN CUS specification is:

$${ConfiguredGain}_{UL} = ( Interface Resolution ) - ( - 1 \; 52 dBm ) + ( GainCorrection ) \qquad ( 2 )$$

where ConfiguredGain_{UL} is measured in decibels (dB), Interface Resolution is measured in dBFS, and GainCorrection is measured in dB. The ConfiguredGain_{UL} may be configured by an O-RU, e.g., and not by an O-DU. For some devices, the RU may not be able to apply the GainCorrection to provide the overall ConfiguredGain_{UL}. For some devices, the RU may not be able to apply the FS offset, and the default value may be set to 0.

In some examples, the FS offset may still be defined from a range of values for each compression type per I/Q bitwidth per eAxC ID. However, issues arise when both GainCorrection and FS offset are set to zero. As the FS offset is an optional parameter, an RU may choose either not to configure the FS offset at all or to set the FS offset to zero. In both scenarios, an FS offset of zero may be applied by, for example, the signal processing component #1 508.

In some examples, the formula for calculating the Interface Resolution in Equation (2) may be defined as:

$$Interface Resolution = - 20 \times log 10 ( {2}^{( Mantissabits ) - 1} \times {2}^{( {2}^{Exponent} - 1 )} ) \qquad ( 3 )$$

Based on Equation (3), for scenarios with no compression, the interface resolution may be calculated to be: Interface Resolution=−20×log 10(2¹⁶⁻¹×2⁰)=−20×log 10(2¹⁵×1)=−90.3 dBFS. For an example with BFP14 compression, the interface resolution is: Interface Resolution=−20×log 10(2⁽¹⁴⁻¹⁾×2²^{⁴}⁻¹)=−20×log 10 (2¹³×2¹⁵)=−168.58 dBFS. The UL data may be transmitted from the RU to the DU with a configured UL gain for each eAxC ID. This gain (e.g., ConfiguredGain_{UL}) may be computed based on Equation (2). In some configurations, the gain correction may be set to zero for both BFP14 and no-compression scenarios, meaning the RU maps −152 dBm to the interface resolution.

Therefore, for some devices, e.g., with no compression, the final dBFS value with a PUSCH transmit power of −94 dBm is calculated as: −94+(−90.3−(−152))=−32.3 dBFS. In the BFP14 compression scenario, with a PUSCH transmit power of −61 dBm, the final dBFS value is: −61+(−168.58−(−152))=−77.58 dBFS.

These calculations show that in the BFP14 compression example, the resulting UL gain is low, leading to a low digital power at the DU. For reliable decoding of PUSCH data by the DU, a substantial gain correction may be applied to increase the RU output power to a range similar to the power observed in non-compression scenarios. For example, a gain correction of +40 dB may be applied to increase the final dBFS value to −37.58 dBFS (calculated as: −61+(−168.58−(−152)+40)=−37.58 dBFS, bringing the power closer to levels seen in non-compression scenarios.

Example aspects presented herein provide methods and apparatus to address the issues faced by RUs when the RU cannot apply the UL gain correction and the FS offset values are not configured (or the FS offset values are set to 0). In some examples, the methods may be triggered when the RU cannot apply the UL gain correction and the FS offset values are not configured (or the FS offset values are set to 0).

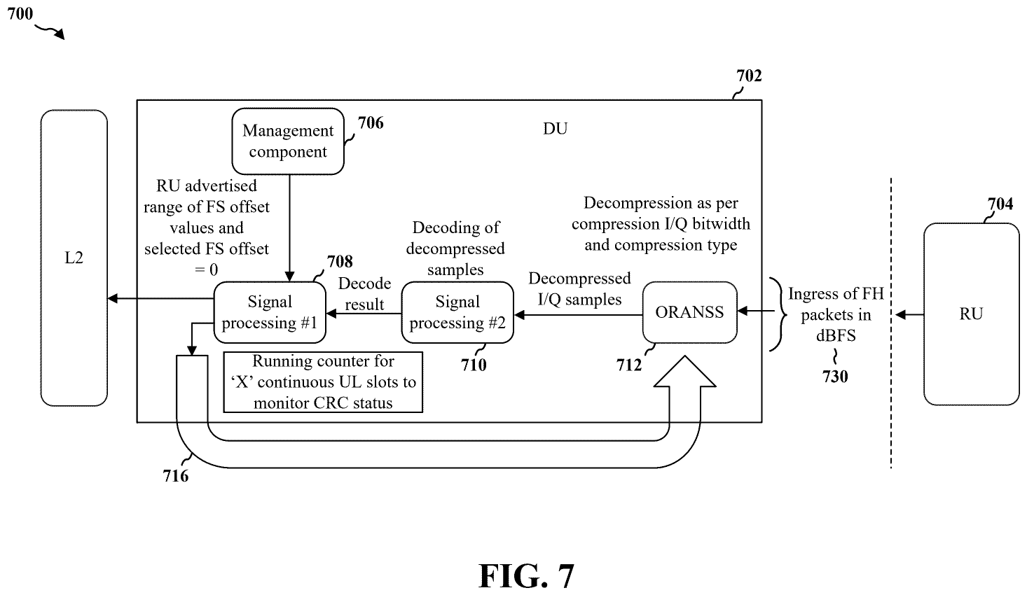

FIG. 7 is a diagram 700 illustrating a dynamic gain correction method in accordance with various aspects of the present disclosures. In FIG. 7, a DU 702 (e.g., an O-DU) may communicate with an RU 704 (e.g., an O-RU). The DU 702 (e.g., an O-DU) may include various components, such as ORANSS 712, a management component 706 (which may include, for example, a management plane (M-plane) module), and various signal processing components, such as signal processing component #1 708 and signal processing component #2 710. For example, the signal processing component #1 708 may include an L1 physical manager, and the signal processing component #2 710 may include an L1 decoder block.

In some aspects, the FH packet digital power, I/Q bitwidth, and the compression method may be known to the ORANSS 712 in the DU 702. In these scenarios, the supported FS offset range may be provided to ORANSS 712 at the startup of the DU 702 via, for example, signal processing component #1 708. In some examples, the firmware of the DU 702 (e.g., the firmware of signal processing component #1 708) may continuously monitor a specified number (e.g., X) of failed (e.g., cyclic redundancy check (CRC) failed) UL slots. For example, if the dynamic power is identified as out of range for these continuous X CRC failing UL slots, the firmware (e.g., the firmware of signal processing component #1 708) may provide a feedback 716 to ORANSS 712. The feedback 716 may specify a pre-defined FS offset value for that CC per endpoint and for each combination of the compression method and I/Q bitwidth. This pre-defined FS offset value may be selected from the supported FS offset range, which may be received at the startup of the DU 702. The process may be iterative repeated, with each step having an adjusted FS offset value until a certain condition (e.g., metric) is met. For example, the condition (or metric) may include that the CRC is passed for X slots, or the FH power is at a proper value within the dynamic range.

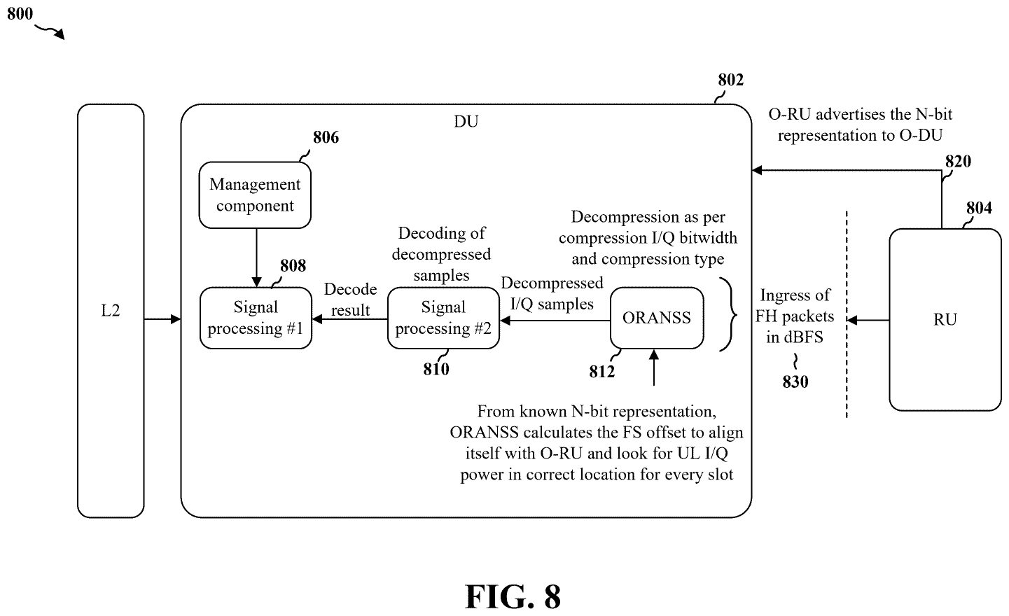

FIG. 8 is a diagram 800 illustrating a dynamic gain correction method in accordance with various aspects of the present disclosures. In FIG. 8, a DU 802 (e.g., an O-DU) may communicate with an RU 804 (e.g., an O-RU). The DU 802 may include various components, such as ORANSS 812, a management component 806 (which may include, for example, a management plane (M-plane) module), and various signal processing components, such as signal processing component #1 808, and signal processing component #2 810. For example, the signal processing component #1 808 may include an L1 physical manager, and the signal processing component #2 810 may include an L1 decoder block.

As shown in FIG. 8, in some examples, the RU 804 may advertise, at 820, the N-bit representation it uses to the DU 802 during, for example, the carrier configuration phase. With knowledge of the N-bit representation, the ORANSS 812 may calculate the appropriate FS offset value or bit-shift value. This calculation may ensure the ORANSS 812 to align itself with the RU 804 (e.g., in terms of the power ranges of the signals), thereby correctly locating the UL IQ power for each slot, avoiding any potential truncation or saturation of the signal. In some examples, to accommodate the transmission of the N-bit representation at 820, a modification to the O-RAN specification may provide a new field in the O-RAN specification, so that the N-bit representation or the bitmap to DU may be transmitted (either optionally or based on a rule) via the new field.

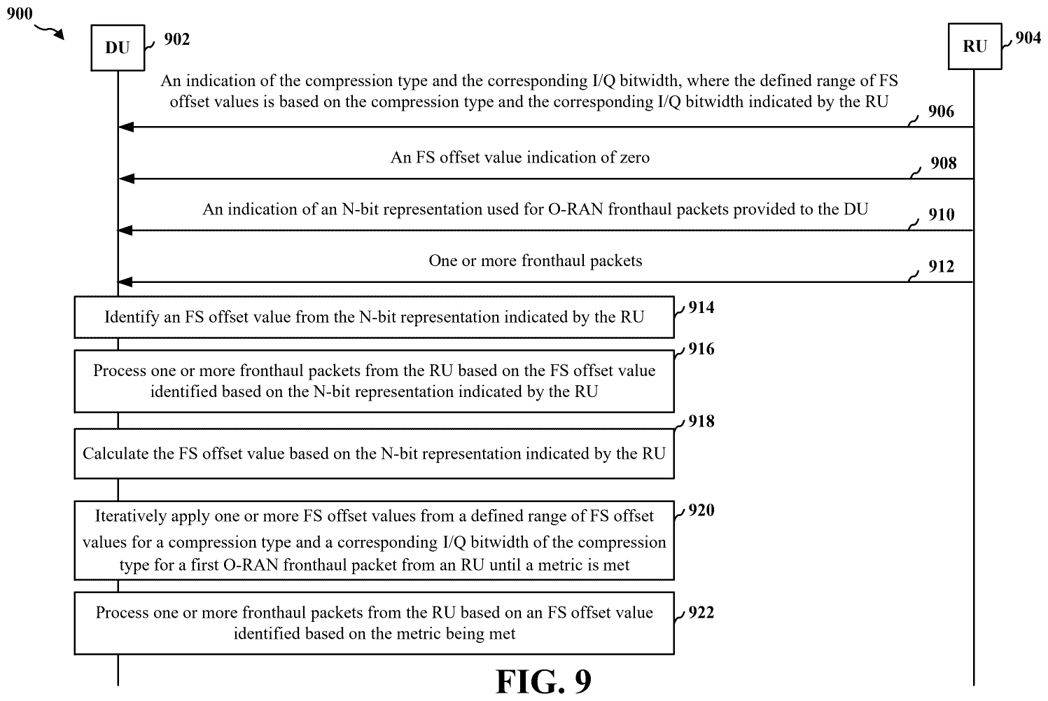

FIG. 9 is a call flow diagram 900 illustrating a method of wireless communication in accordance with various aspects of this present disclosure. Various aspects are described in connection with a DU 902 (e.g., which may include aspects described in connection with the DU 130, 702, and/or 802, O-DU 502) and a RU 904 (e.g., which may include aspects described in connection with the RU 140, 704, or 804, O-RU 504). The aspects may be performed by the DU 902 or the RU 904. The DU may be, for example, DU 130, 702, or 802. The RU may be, for example, RU 140, 704, or 804.

As shown in FIG. 9, a DU 902 may, at 906, receive from the RU 904, an indication of the compression type and the corresponding I/Q bitwidth. The defined range of FS offset values may be based on the compression type and the corresponding I/Q bitwidth indicated by the RU 904.

At 908, the DU 902 may receive from the RU 904 an FS offset value indication of zero.

At 910, the DU 902 may receive from the RU 904 an indication of an N-bit representation used for O-RAN fronthaul packets provided to the DU 902. For example, referring to FIG. 8, the DU 802 may receive, at 820, from the RU 804 an indication of an N-bit representation used for O-RAN fronthaul packets provided to the DU.

At 912, the DU 902 may receive from the RU 904 one or more fronthaul packets. For example, referring to FIG. 7, the DU 702 may receive from the RU 704 one or more fronthaul packets at 730. Referring to FIG. 8, the DU 802 may receive from the RU 804 one or more fronthaul packets at 830.

At 914, the DU 902 may identify an FS offset value from the N-bit representation indicated by the RU 904 (at 910).

At 916, the DU 902 may process one or more fronthaul packets from the RU 904 based on the FS offset value identified based on the N-bit representation indicated by the RU 904. For example, referring to FIG. 8, the DU 802 (e.g., the ORANSS 812) may process (e.g., decompress) one or more fronthaul packets from the RU 804 based on the FS offset value identified based on the N-bit representation indicated by the RU 804.

At 918, the DU 902 may calculate the FS offset value based on the N-bit representation indicated by the RU 904. For example, referring to FIG. 8, the DU 802 (e.g., ORANSS 812) may calculate the FS offset value based on the N-bit representation indicated by the RU 804 at 820.

At 920, the DU 902 may iteratively apply one or more FS offset values from a defined range of FS offset values for a compression type and a corresponding I/Q bitwidth of the compression type for a first O-RAN fronthaul packet from an RU 904 until a metric is met. For example, referring to FIG. 7, the DU 702 (e.g., ORANSS 712) may iteratively apply one or more FS offset values (provided by feedback 716 from the signal processing component #1 708) from a defined range of FS offset values for a compression type and a corresponding I/Q bitwidth of the compression type for a first O-RAN fronthaul packet from an RU 704 until a metric is met. For example, the metric may include the CRC is passed for a certain number (e.g., X) of slots, or the FH power is at a proper value within the dynamic range of DU 702.

At 922, the DU 902 may process one or more fronthaul packets from the RU 904 based on an FS offset value identified based on the metric being met. For example, referring to FIG. 7, the DU 702 (e.g., ORANSS 712) may process one or more fronthaul packets from the RU 704 (e.g., via 730) based on an FS offset value identified based on the metric being met (e.g., the CRC is passed for a certain number (e.g., X) of slots under the FS offset value).

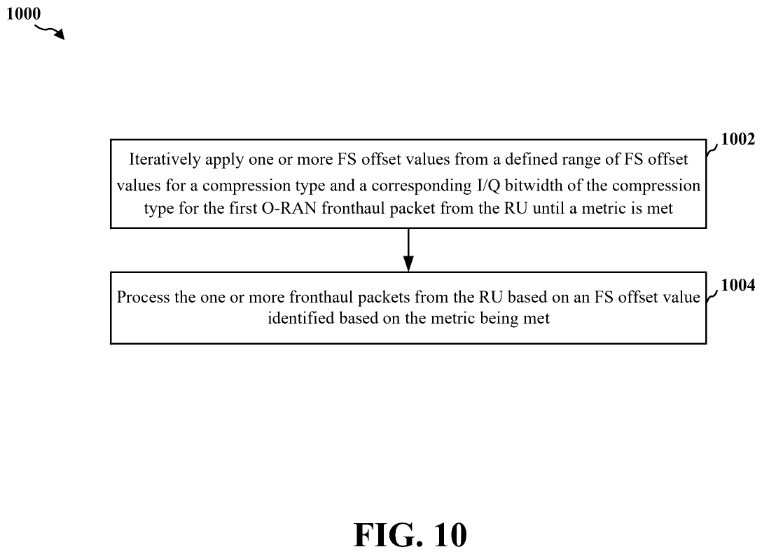

FIG. 10 is a flowchart 1000 illustrating methods of wireless communication at a DU in accordance with various aspects of the present disclosure. The method may be performed by a DU as a network node (e.g., DU 130, 702, 802, 902, or 1630). In some examples, by allowing for dynamic adjustment of the FS offset based on real-time conditions, the methods enhance flexibility in handling various signal conditions. In some examples, by implementing a fallback mechanism that utilizes pre-defined FS offset values when automatic gain correction is not available, the methods ensure continuous system operations, even under less-than-ideal conditions.

In some examples, the DU may receive a first O-RAN fronthaul packet from an RU. The RU may be RU 140, 704, 804, 904, or 1640, for example.

As shown in FIG. 10, at 1002, the DU may iteratively apply one or more FS offset values from a defined range of FS offset values for a compression type and a corresponding I/Q bitwidth of the compression type for a first O-RAN fronthaul packet from the RU until a metric is met. FIG. 7, FIG. 8, and FIG. 9 illustrate various aspects of the steps in connection with flowchart 1000. For example, referring to FIG. 9, the DU 902 may, at 920, iteratively apply one or more FS offset values from a defined range of FS offset values for a compression type and a corresponding I/Q bitwidth of the compression type for the first O-RAN fronthaul packet from an RU 904 until a metric is met. For example, referring to FIG. 7, the DU 702 (e.g., ORANSS 712) may iteratively apply one or more FS offset values (provided by feedback 716 from the signal processing component #1 708) from a defined range of FS offset values for a compression type and a corresponding I/Q bitwidth of the compression type for the first O-RAN fronthaul packet from an RU 704 until a metric is met. For example, the metric may include the CRC is passed for a certain number (e.g., X) of slots, or the FH power is at a proper value within the dynamic range of DU 702. In some aspects, 1002 may be performed by the dynamic gain correction component 199.

In some examples, the DU may receive one or more fronthaul packets from the RU. For example, referring to FIG. 9, the DU 902 may, at 912, receive one or more fronthaul packets from the RU 904.

At 1004, the DU may process the one or more fronthaul packets from the RU based on an FS offset value identified based on the metric being met. For example, referring to FIG. 9, the DU 902 may, at 922, process one or more fronthaul packets from the RU 904 (via 912) based on an FS offset value identified based on the metric being met. Referring to FIG. 7, the DU 702 (e.g., ORANSS 712) may process one or more fronthaul packets from the RU 704 (e.g., via 730) based on an FS offset value identified based on the metric being met (e.g., the CRC is passed for a certain number (e.g., X) of slots under the FS offset value). In some aspects, 1004 may be performed by the dynamic gain correction component 199.

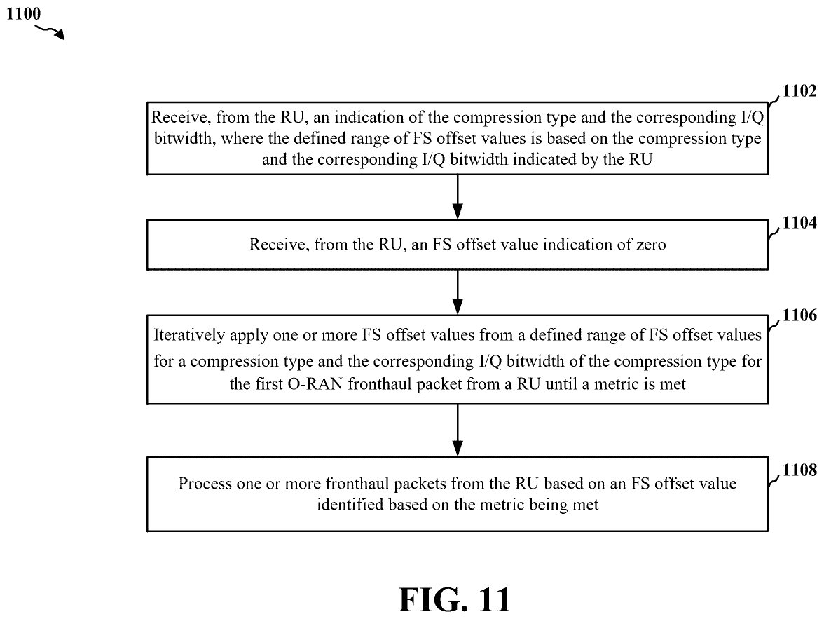

FIG. 11 is a flowchart 1100 illustrating methods of wireless communication at a DU in accordance with various aspects of the present disclosure. The method may be performed by a DU as a network node (e.g., DU 130, 702, 802, 902, or 1630). In some examples, by allowing for dynamic adjustment of the FS offset based on real-time conditions, the methods enhance flexibility in handling various signal conditions. In some examples, by implementing a fallback mechanism that utilizes pre-defined FS offset values when automatic gain correction is not available, the methods ensure continuous system operations, even under less-than-ideal conditions.

In some examples, the DU may receive a first O-RAN fronthaul packet from an RU. The RU may be RU 140, 704, 804, 904, or 1640, for example.

As shown in FIG. 11, at 1106, the DU may iteratively apply one or more FS offset values from a defined range of FS offset values for a compression type and a corresponding I/Q bitwidth of the compression type for a first O-RAN fronthaul packet from an RU until a metric is met. FIG. 7, FIG. 8, and FIG. 9 illustrate various aspects of the steps in connection with flowchart 1100. For example, referring to FIG. 9, the DU 902 may, at 920, iteratively apply one or more FS offset values from a defined range of FS offset values for a compression type and a corresponding I/Q bitwidth of the compression type for a first O-RAN fronthaul packet from an RU 904 until a metric is met. For example, referring to FIG. 7, the DU 702 (e.g., ORANSS 712) may iteratively apply one or more FS offset values (provided by feedback 716 from the signal processing component #1 708) from a defined range of FS offset values for a compression type and a corresponding I/Q bitwidth of the compression type for a first O-RAN fronthaul packet from an RU 704 until a metric is met. For example, the metric may include the CRC is passed for a certain number (e.g., X) of slots, or the FH power is at a proper value within the dynamic range of DU 702. In some aspects, 1106 may be performed by the dynamic gain correction component 199.

In some examples, the DU may receive one or more fronthaul packets from the RU. For example, referring to FIG. 9, the DU 902 may, at 912, receive one or more fronthaul packets from the RU 904.

At 1108, the DU may process the one or more fronthaul packets from the RU based on an FS offset value identified based on the metric being met. For example, referring to FIG. 9, the DU 902 may, at 922, process one or more fronthaul packets from the RU 904 (via 912) based on an FS offset value identified based on the metric being met. Referring to FIG. 7, the DU 702 (e.g., ORANSS 712) may process the one or more fronthaul packets from the RU 704 (e.g., via 730) based on an FS offset value identified based on the metric being met (e.g., the CRC is passed for a certain number (e.g., X) of slots under the FS offset value). In some aspects, 1108 may be performed by the dynamic gain correction component 199.

In some aspects, the DU may iteratively apply the one or more FS offset values from the defined range of FS offset values until a received power meets a threshold. For example, referring to FIG. 7, the DU 702 (e.g., ORANSS 712) may iteratively apply the one or more FS offset values from the defined range of FS offset values until a received power meets a threshold.

In some aspects, the DU may iteratively apply the one or more FS offset values from the defined range of FS offset values until a CRC condition is met (e.g., a CRC of UL O-RAN FH packet is passed). For example, referring to FIG. 7, the DU 702 (e.g., ORANSS 712) may iteratively apply the one or more FS offset values from the defined range of FS offset values until a CRC of UL O-RAN FH packet is passed (e.g., the CRC is passed for a certain number of slots).

In some examples, the CRC condition is associated with the one or more fronthaul packets from the RU over a fronthaul interface, and the CRC condition includes the CRC is passed for a first number of slots under the one or more FS offset values.

In some examples, the slots include uplink slots.

In some aspects, at 1102, the DU may receive, from the RU, an indication of the compression type and the corresponding I/Q bitwidth. The defined range of FS offset values may be based on the compression type and the corresponding I/Q bitwidth indicated by the RU. For example, referring to FIG. 9, the DU 902 may receive, at 906, from the RU 904, an indication of the compression type and the corresponding I/Q bitwidth. The defined range of FS offset values may be based on the compression type and the corresponding I/Q bitwidth indicated by the RU 904. In some aspects, 1102 may be performed by the dynamic gain correction component 199.

In some aspects, to iteratively apply the one or more FS offset values (at 1106), the DU may iteratively apply the one or more FS offset values based on a dynamic power for the first O-RAN fronthaul packet from the RU being out of a range supported by the DU for one or more continuous slots. For example, referring to FIG. 9, to iteratively apply the one or more FS offset values (at 920), the DU 902 may iteratively apply the one or more FS offset values based on a dynamic power for the first O-RAN fronthaul packet from the RU 904 being out of a range supported by the DU 902 for one or more continuous slots.

In some aspects, at 1104, the DU may receive, from the RU, an FS offset value indication of zero. For example, referring to FIG. 9, the DU 902 may receive, at 908, from the RU 904, an FS offset value indication of zero. In some aspects, 1104 may be performed by the dynamic gain correction component 199.

In some aspects, the one or more fronthaul packets may be received without gain correction. For example, referring to FIG. 9, the one or more fronthaul packets may be received at 912 without gain correction.

In some examples, the DU may monitor for a decode failure on a first number of slots. To iteratively apply the one or more FS offset values from the defined range of FS offset values (e.g., at 1106), the DU may iteratively apply, in response to the decode failure on the first number of slots, the one or more FS offset values from the defined range of FS offset values.

In some examples, the decode failure on the first number of slots may include: a CRC failure on the first number of slots.

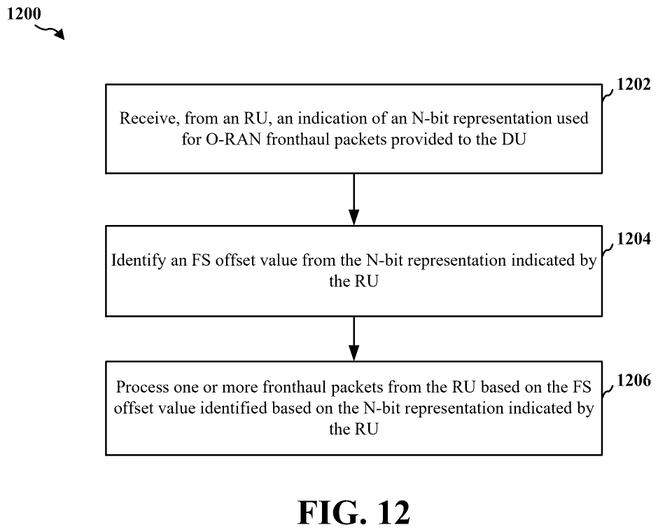

FIG. 12 is a flowchart 1200 illustrating methods of wireless communication at a DU in accordance with various aspects of the present disclosure. The method may be performed by a DU as a network node (e.g., DU 130, 702, 802, 902, or 1630). In some examples, by allowing for dynamic adjustment of the FS offset based on real-time conditions, the methods enhance flexibility in handling various signal conditions. In some examples, by implementing a fallback mechanism that utilizes pre-defined FS offset values when automatic gain correction is not available, the methods ensure continuous system operations, even under less-than-ideal conditions.

As shown in FIG. 12, at 1202, the DU may receive, from an RU, an indication of an N-bit representation used for O-RAN fronthaul packets provided to the DU. The RU may be RU 140, 704, 804, 904, or 1640, for example. FIG. 7, FIG. 8, and FIG. 9 illustrate various aspects of the steps in connection with flowchart 1200. For example, referring to FIG. 9, the DU 902 may receive, at 910, from an RU 904, an indication of an N-bit representation used for O-RAN fronthaul packets provided to the DU. Referring to FIG. 8, the DU 802 may receive, at 820, from an RU 804, an indication of an N-bit representation used for O-RAN fronthaul packets provided to the DU 802. In some aspects, 1202 may be performed by the dynamic gain correction component 199.

At 1204, the DU may identify an FS offset value from the N-bit representation indicated by the RU. For example, referring to FIG. 9, the DU 902 may identify, at 914, an FS offset value from the N-bit representation indicated by the RU 904. In some aspects, 1204 may be performed by the dynamic gain correction component 199.

At 1206, the DU may process one or more fronthaul packets from the RU based on the FS offset value identified based on the N-bit representation indicated by the RU. For example, referring to FIG. 9, the DU 902 may, at 916, process one or more fronthaul packets from the RU based on the FS offset value identified based on the N-bit representation indicated by the RU 904 (at 910). In some aspects, 1206 may be performed by the dynamic gain correction component 199.

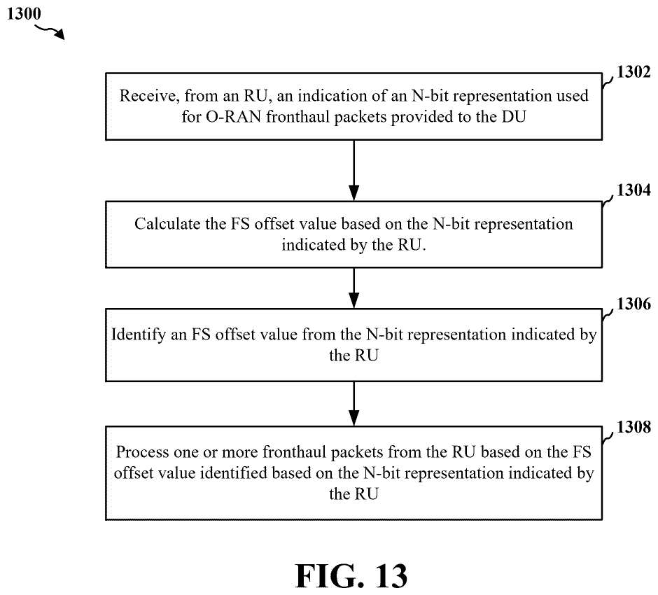

FIG. 13 is a flowchart 1300 illustrating methods of wireless communication at a DU in accordance with various aspects of the present disclosure. The method may be performed by a DU as a network node (e.g., DU 130, 702, 802, 902, or 1630). In some examples, by allowing for dynamic adjustment of the FS offset based on real-time conditions, the methods enhance flexibility in handling various signal conditions. In some examples, by implementing a fallback mechanism that utilizes pre-defined FS offset values when automatic gain correction is not available, the methods ensure continuous system operations, even under less-than-ideal conditions.

As shown in FIG. 13, at 1302, the DU may receive, from an RU, an indication of an N-bit representation used for O-RAN fronthaul packets provided to the DU. The RU may be RU 140, 704, 804, 904, or 1640, for example. FIG. 7, FIG. 8, and FIG. 9 illustrate various aspects of the steps in connection with flowchart 1300. For example, referring to FIG. 9, the DU 902 may receive, at 910, from an RU 904, an indication of an N-bit representation used for O-RAN fronthaul packets provided to the DU. Referring to FIG. 8, the DU 802 may receive, at 820, from an RU 804, an indication of an N-bit representation used for O-RAN fronthaul packets provided to the DU 802. In some aspects, 1302 may be performed by the dynamic gain correction component 199.

At 1306, the DU may identify an FS offset value from the N-bit representation indicated by the RU. For example, referring to FIG. 9, the DU 902 may identify, at 914, an FS offset value from the N-bit representation indicated by the RU 904. In some aspects, 1306 may be performed by the dynamic gain correction component 199.

At 1308, the DU may process one or more fronthaul packets from the RU based on the FS offset value identified based on the N-bit representation indicated by the RU. For example, referring to FIG. 9, the DU 902 may, at 916, process one or more fronthaul packets from the RU based on the FS offset value identified based on the N-bit representation indicated by the RU 904 (at 910). In some aspects, 1308 may be performed by the dynamic gain correction component 199.

In some aspects, at 1304, the DU may calculate the FS offset value based on the N-bit representation indicated by the RU. For example, referring to FIG. 9, the DU 902 may, at 918, calculate the FS offset value based on the N-bit representation indicated by the RU 904 (at 910). In some aspects, 1304 may be performed by the dynamic gain correction component 199.

In some aspects, the FS offset value may correspond to a bit-shift value to align bits used by the DU for decoding compressed packets with bits that carry information from the RU. For example, referring to FIG. 8, the FS offset value may correspond to a bit-shift value to align bits used by the DU 802 for decoding compressed packets with bits that carry information from the RU 804.

In some aspects, the DU may calculate a bit-shift value based on the N-bit representation indicated by the RU, and the bit-shift value aligns bits used by the DU for decoding compressed packets with bits that carry information from the RU.

In some aspects, the DU may locate an uplink I/Q power for one or more uplink slots based on the FS offset value.

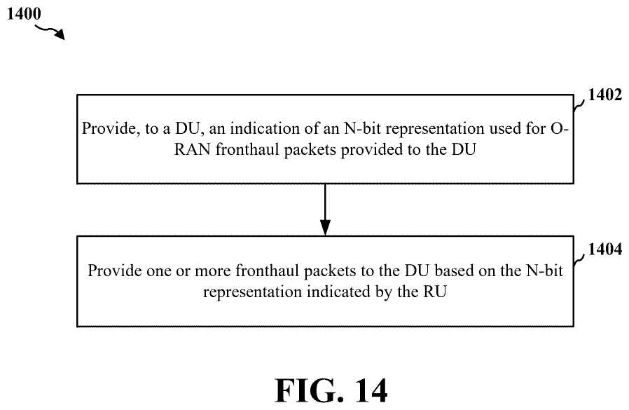

FIG. 14 is a flowchart 1400 illustrating methods of wireless communication at an RU in accordance with various aspects of the present disclosure. The method may be performed by the RU as a network node (e.g., RU 140, 704, 804, 904, or 1640). In some examples, by allowing for dynamic adjustment of the FS offset based on real-time conditions, the methods enhance flexibility in handling various signal conditions. In some examples, by implementing a fallback mechanism that utilizes pre-defined FS offset values when automatic gain correction is not available, the methods ensure continuous system operations, even under less-than-ideal conditions.

As shown in FIG. 14, at 1402, the RU may provide, to a DU, an indication of an N-bit representation used for O-RAN fronthaul packets provided to the DU. The DU may be the DU 130, 702, 802, 902, or 1630, for example. FIG. 7, FIG. 8, and FIG. 9 illustrate various aspects of the steps in connection with flowchart 1400. For example, referring to FIG. 9, the RU 904 may provide, at 910, to a DU 902, an indication of an N-bit representation used for O-RAN fronthaul packets provided to the DU. Referring to FIG. 8, the RU 804 may provide, at 820, to a DU 802, an indication of an N-bit representation used for O-RAN fronthaul packets provided to the DU 802. In some aspects, 1402 may be performed by the dynamic gain correction component 199, e.g., of the RU 1640.

At 1404, the RU may provide one or more fronthaul packets to the DU based on the N-bit representation indicated by the RU. For example, referring to FIG. 9, the RU 904 may, at 912, provide one or more fronthaul packets to the DU 902 based on the N-bit representation indicated by the RU 904. In some aspects, 1404 may be performed by the dynamic gain correction component 199, e.g., of the RU 1640.

In some aspects, the N-bit representation may enable the DU to calculate an FS offset value for the one or more fronthaul packets. For example, referring to FIG. 9, the N-bit representation may enable the DU 902 to calculate, at 918, an FS offset value for the one or more fronthaul packets (received at 912).

In some aspects, the FS offset value may correspond to a bit-shift value to align bits used by the DU for decoding compressed packets with bits that carry information from the RU. For example, referring to FIG. 9, the FS offset value (e.g., at 918, or 920) may correspond to a bit-shift value to align bits used by the DU 902 for decoding compressed packets with bits that carry information from the RU 904.

In some aspects, the N-bit representation enables the DU to calculate a bit-shift value. The bit-shift value aligns bits used by the DU for decoding compressed packets with bits that carry information from the RU.

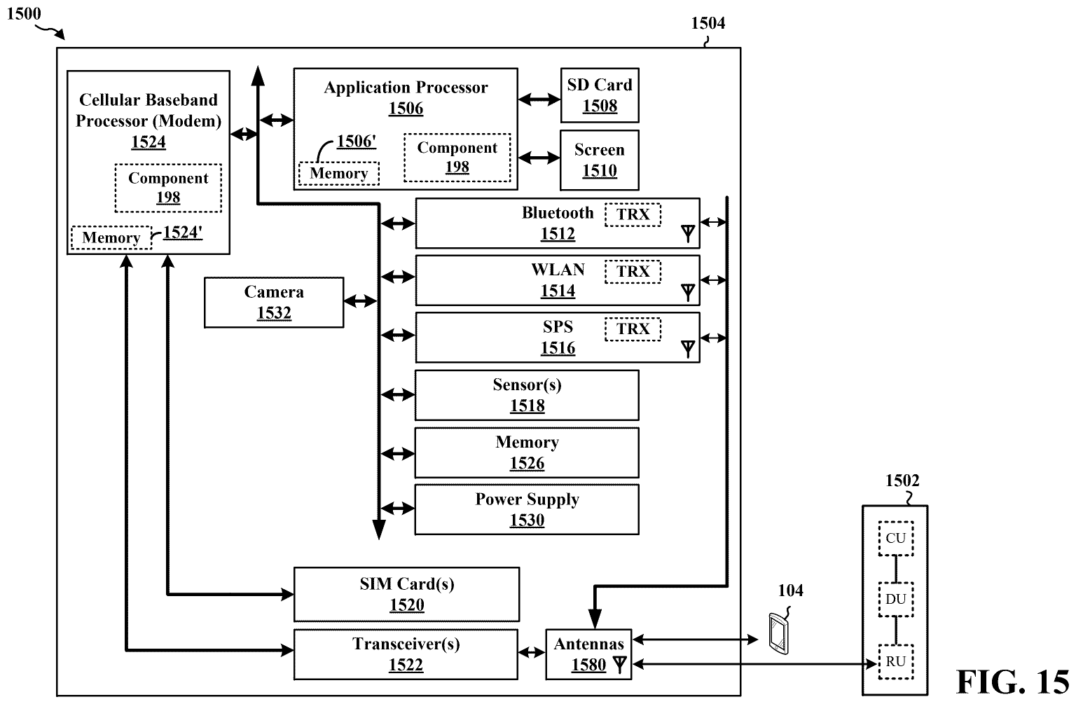

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

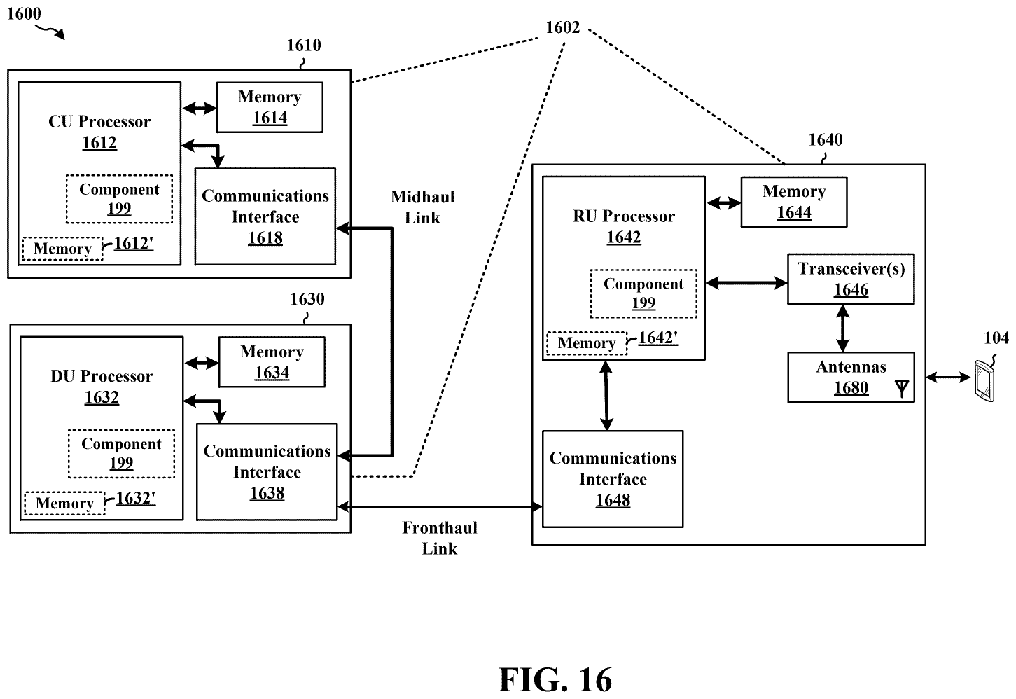

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648. The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, in some aspects, the component 199 may be included in the DU 1630 and may be configured to receive a first O-RAN fronthaul packet from an RU; iteratively apply one or more FS offset values from a defined range of FS offset values for a compression type and a corresponding I/Q bitwidth of the compression type for the first O-RAN fronthaul packet from the RU until a metric is met; receive one or more fronthaul packets from the RU; and process the one or more fronthaul packets from the RU based on an FS offset value identified based on the metric being met. In some aspects, the component 199 may be configured to receive, from an RU, an indication of an N-bit representation used for O-RAN fronthaul packets provided to the DU; identify an FS offset value from the N-bit representation indicated by the RU; and process one or more fronthaul packets from the RU based on the FS offset value identified based on the N-bit representation indicated by the RU. In some aspects, the component 199 may be included in the RU 1640 and may be configured to provide, to a DU, an indication of an N-bit representation used for O-RAN fronthaul packets provided to the DU; and provide one or more fronthaul packets to the DU based on the N-bit representation indicated by the RU.

The component 199, e.g., at the DU 1630 may be further configured to perform any of the aspects described in connection with the flowcharts in FIG. 10, FIG. 11, FIG. 12, FIG. 13 and/or performed by the DU in any of FIGS. 7-9. In some aspects, the component 199, e.g., at the RU 1640, may be further configured to perform any of the aspects described in connection with the flowchart in FIG. 14 and/or performed by the RU in any of FIGS. 7-9. The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for receiving a first O-RAN fronthaul packet from an RU; means for iteratively applying one or more FS offset values from a defined range of FS offset values for a compression type and a corresponding I/Q bitwidth of the compression type for the first O-RAN fronthaul packet from the RU until a metric is met; means for receiving one or more fronthaul packets from the UR; and means for processing the one or more fronthaul packets from the RU based on an FS offset value identified based on the metric being met. In one configuration, the network entity 1602 may include means for receiving, from an RU, an indication of an N-bit representation used for O-RAN fronthaul packets provided to the DU; means for identifying an FS offset value from the N-bit representation indicated by the RU; and means for processing one or more fronthaul packets from the RU based on the FS offset value identified based on the N-bit representation indicated by the RU. In one configuration, the network entity 1602 may include means for providing, to a DU, an indication of an N-bit representation used for O-RAN fronthaul packets provided to the DU; and means for providing one or more fronthaul packets to the DU based on the N-bit representation indicated by the RU. The network entity 1602 may further include means for performing any of the aspects described in connection with the flowcharts in FIG. 10, FIG. 11, FIG. 12, FIG. 13, FIG. 14, and/or aspects performed by the RU 904 in FIG. 9. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a DU. The method may include receiving a first O-RAN fronthaul packet from an RU; iteratively applying one or more FS offset values from a defined range of FS offset values for a compression type and a corresponding I/Q bitwidth of the compression type for the first O-RAN fronthaul packet from the RU until a metric is met; receiving one or more fronthaul packets from the RU; and processing the one or more fronthaul packets from the RU based on an FS offset value identified based on the metric being met. In some examples, by allowing for dynamic adjustment of the FS offset based on real-time conditions, the methods enhance flexibility in handling various signal conditions. In some examples, by implementing a fallback mechanism that utilizes pre-defined FS offset values when automatic gain correction is not available, the methods ensure continuous system operations, even under less-than-ideal conditions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a DU. The method includes receiving a first open radio access network (O-RAN) fronthaul packet from a radio unit (RU); iteratively applying one or more full scale (FS) offset values from a defined range of FS offset values for a compression type and a corresponding In-phase/Quadrature (I/Q) bitwidth of the compression type for the first O-RAN fronthaul packet from the RU until a metric is met; receiving one or more fronthaul packets from the RU; and processing the one or more fronthaul packets from the RU based on an FS offset value identified based on the metric being met.

Aspect 2 is the method of aspect 1, wherein the DU iteratively applies the one or more FS offset values from the defined range of FS offset values until a received power meets a threshold.

Aspect 3 is the method of aspect 1, wherein the DU iteratively applies the one or more FS offset values from the defined range of FS offset values until a cyclic redundancy check (CRC) condition is met.

Aspect 4 is the method of aspect 3, wherein the CRC condition is associated with the one or more fronthaul packets from the RU over a fronthaul interface, and wherein the CRC condition is based on a CRC that is passed for a first number of slots under the one or more FS offset values.

Aspect 5 is the method of aspect 4, wherein the first number of slots include uplink slots.

Aspect 6 is the method of any of aspects 1 to 5, where the method further includes receiving, from the RU, an indication of the compression type and the I/Q bitwidth, wherein the defined range of FS offset values is based on the compression type and the I/Q bitwidth indicated by the RU.

Aspect 7 is the method of any of aspects 1 to 6, wherein to iteratively apply the one or more FS offset values, the DU may iteratively apply the one or more FS offset values based on a dynamic power for the first O-RAN fronthaul packet from the RU being out of a range supported by the DU for one or more continuous slots.

Aspect 8 is the method of any of aspects 1 to 7, where the method further includes receiving, from the RU, an FS offset value indication of zero.

Aspect 9 is the method of aspect 1, wherein the one or more fronthaul packets are received without gain correction.

Aspect 10 is the method of any of aspects 1 to 9, where the method further includes monitoring for a decode failure on a first number of slots, wherein iteratively applying the one or more FS offset values from the defined range of FS offset values comprises: iteratively applying, in response to the decode failure on the first number of slots, the one or more FS offset values from the defined range of FS offset values.

Aspect 11 is the method of aspect 10, wherein the decode failure on the first number of slots includes: a cyclic redundancy check (CRC) failure on the first number of slots.

Aspect 12 is an apparatus for wireless communication at a DU, comprising: at least one memory; and at least one processor coupled to the at least one memory, the at least one processor is configured to perform the method of any of aspects 1 to 11.

Aspect 13 is the apparatus for wireless communication at a DU, comprising means for performing each step in the method of any of aspects 1 to 11.

Aspect 14 is an apparatus of any of aspects 12-13, further comprising a transceiver configured to receive or to transmit in association with the method of any of aspects 1 to 11.

Aspect 15 is a computer-readable medium (e.g., a non-transitory computer-readable medium) storing computer executable code at a DU, the code when executed by at least one processor causes the at least one processor to perform the method of any of aspects 1 to 11.

Aspect 16 is a method of wireless communication at a DU. The method includes receiving, from an RU, an indication of an N-bit representation used for O-RAN fronthaul packets provided to the DU; identifying an FS offset value from the N-bit representation indicated by the RU; and processing one or more fronthaul packets from the RU based on the FS offset value identified based on the N-bit representation indicated by the RU.

Aspect 17 is the method of aspect 16, where the method further includes calculating the FS offset value based on the N-bit representation indicated by the RU.

Aspect 18 is the method of aspect 17, wherein the FS offset value may correspond to a bit-shift value to align bits used by the DU for decoding compressed packets with bits that carry information from the RU.

Aspect 19 is the method of aspect 17, where the method further includes calculating a bit-shift value based on the N-bit representation indicated by the RU, wherein the bit-shift value aligns bits used by the DU for decoding compressed packets with bits that carry information from the RU.

Aspect 20 is the method of aspect 17, where the method further includes locating an uplink In-phase/Quadrature (I/Q) power for one or more uplink slots based on the FS offset value.

Aspect 21 is an apparatus for wireless communication at a DU, comprising: at least one memory; and at least one processor coupled to the at least one memory, the at least one processor is configured to perform the method of any of aspects 16 to 20.

Aspect 22 is the apparatus for wireless communication at a DU, comprising means for performing each step in the method of any of aspects 16 to 20.

Aspect 23 is an apparatus of any of aspects 21-22, further comprising a transceiver configured to receive or to transmit in association with the method of any of aspects 16 to 20.

Aspect 24 is a computer-readable medium (e.g., a non-transitory computer-readable medium) storing computer executable code at a DU, the code when executed by at least one processor causes the at least one processor to perform the method of any of aspects 16 to 20.

Aspect 25 is a method of wireless communication at an RU. The method includes providing, to a DU, an indication of an N-bit representation used for O-RAN fronthaul packets provided to the DU; and providing one or more fronthaul packets to the DU based on the N-bit representation indicated by the RU.

Aspect 26 is the method of aspect 25, wherein the N-bit representation may enable the DU to calculate an FS offset value for the one or more fronthaul packets.

Aspect 27 is the method of aspect 26, wherein the FS offset value may correspond to a bit-shift value to align bits used by the DU for decoding compressed packets with bits that carry information from the RU.

Aspect 28 is the method of any of aspects 26 to 27, wherein the N-bit representation enables the DU to calculate a bit-shift value, wherein the bit-shift value aligns bits used by the DU for decoding compressed packets with bits that carry information from the RU.

Aspect 29 is an apparatus for wireless communication at an RU, comprising: at least one memory; and at least one processor coupled to the at least one memory, the at least one processor is configured to perform the method of any of aspects 25 to 28.

Aspect 30 is the apparatus for wireless communication at an RU, comprising means for performing each step in the method of any of aspects 25 to 28.

Aspect 31 is an apparatus of any of aspects 29-30, further comprising a transceiver configured to receive or to transmit in association with the method of any of aspects 25 to 28.

Aspect 32 is a computer-readable medium (e.g., a non-transitory computer-readable medium) storing computer executable code at an RU, the code when executed by at least one processor causes the at least one processor to perform the method of any of aspects 25 to 28.

What is claimed is:

1. An apparatus for wireless communication at a distributed unit (DU), comprising:
at least one memory; and
at least one processor coupled to the at least one memory and, based at least in part on stored information that is stored in the at least one memory, the at least one processor is configured to cause the DU to:
receive a first open radio access network (O-RAN) fronthaul packet from a radio unit (RU);
iteratively apply one or more full scale (FS) offset values from a defined range of FS offset values for a compression type and a corresponding In-phase/Quadrature (I/Q) bitwidth of the compression type for the first O-RAN fronthaul packet from the RU until a metric is met;
receive one or more fronthaul packets from the RU; and
process the one or more fronthaul packets from the RU based on an FS offset value identified based on the metric being met.

2. The apparatus of claim 1, further comprising a transceiver coupled to the at least one processor, wherein to process the one or more fronthaul packets, the at least one processor is configured to cause the DU to process the one or more fronthaul packets via the transceiver, and wherein the DU iteratively applies the one or more FS offset values from the defined range of FS offset values until a received power meets a threshold.

3. The apparatus of claim 1, wherein the DU iteratively applies the one or more FS offset values from the defined range of FS offset values until a cyclic redundancy check (CRC) condition is met.

4. The apparatus of claim 3, wherein the CRC condition is associated with the one or more fronthaul packets from the RU over a fronthaul interface, and wherein the CRC condition is based on a CRC that is passed for a first number of slots under the one or more FS offset values.

5. The apparatus of claim 4, wherein the first number of slots include uplink slots.

6. The apparatus of claim 1, wherein the at least one processor is further configured to cause the DU to:
receive, from the RU, an indication of the compression type and the I/Q bitwidth, wherein the defined range of FS offset values is based on the compression type and the I/Q bitwidth indicated by the RU.

7. The apparatus of claim 1, wherein to iteratively apply the one or more FS offset values, the at least one processor is configured to cause the DU to iteratively apply the one or more FS offset values based on a dynamic power for the first O-RAN fronthaul packet from the RU being out of a range supported by the DU for one or more continuous slots.

8. The apparatus of claim 1, wherein the at least one processor is further configured to cause the DU to:
receive, from the RU, an FS offset value indication of zero.

9. The apparatus of claim 1, wherein the one or more fronthaul packets are received without gain correction.

10. The apparatus of claim 1, wherein the at least one processor is further configured to cause the DU to:
monitor for a decode failure on a first number of slots, wherein to iterative apply the one or more FS offset values from the defined range of FS offset values, the at least one processor is configured to:
iteratively apply, in response to the decode failure on the first number of slots, the one or more FS offset values from the defined range of FS offset values.

11. The apparatus of claim 10, wherein the decode failure on the first number of slots includes:
a cyclic redundancy check (CRC) failure on the first number of slots.

12. An apparatus for wireless communication at a distributed unit (DU), comprising:
at least one memory; and
at least one processor coupled to the at least one memory and, based at least in part on information stored in the at least one memory, the at least one processor is configured to cause the DU to:
receive, from a radio unit (RU), an indication of an N-bit representation used for open radio access network (O-RAN) fronthaul packets provided to the DU;
identify an FS offset value from the N-bit representation indicated by the RU; and
process one or more fronthaul packets from the RU based on the FS offset value identified based on the N-bit representation indicated by the RU.

13. The apparatus of claim 12, further comprising a transceiver coupled to the at least one processor, wherein to receive the indication of the N-bit representation, the at least one processor is configured to cause the DU to receive the indication of the N-bit representation the transceiver, and wherein the at least one processor is further configured to cause the DU to:
calculate the FS offset value based on the N-bit representation indicated by the RU.

14. The apparatus of claim 13, wherein the FS offset value corresponds to a bit-shift value to align bits used by the DU for decoding compressed packets with bits that carry information from the RU.

15. The apparatus of claim 13, wherein the at least one processor is further configured to:
calculate a bit-shift value based on the N-bit representation indicated by the RU, wherein the bit-shift value aligns bits used by the DU for decoding compressed packets with bits that carry information from the RU.

16. The apparatus of claim 13, wherein the at least one processor is further configured to:
locate an uplink In-phase/Quadrature (I/Q) power for one or more uplink slots based on the FS offset value.

17. An apparatus for wireless communication at a radio unit (RU), comprising:
at least one memory; and
at least one processor coupled to the at least one memory and, based at least in part on stored information that is stored in the at least one memory, the at least one processor is configured to cause the RU to:
provide, to a distributed unit (DU), an indication of an N-bit representation used for open radio access network (O-RAN) fronthaul packets provided to the DU; and
provide one or more fronthaul packets to the DU based on the N-bit representation indicated by the RU.

18. The apparatus of claim 17, further comprising a transceiver coupled to the at least one processor, wherein to provide the indication of the N-bit representation, the at least one processor is configured to cause the RU to provide the indication of the N-bit representation via the transceiver, and wherein the N-bit representation enables the DU to calculate an FS offset value for the one or more fronthaul packets.

19. The apparatus of claim 18, wherein the FS offset value corresponds to a bit-shift value to align bits used by the DU for decoding compressed packets with bits that carry information from the RU.

20. The apparatus of claim 18, wherein the N-bit representation enables the DU to calculate a bit-shift value, wherein the bit-shift value aligns bits used by the DU for decoding compressed packets with bits that carry information from the RU.
